(19) United States
(12) Patent Application Publication
(10) Pub. No.: US 2013/0043051 A1
(43) Pub. Date: Feb. 21, 2013

(54) AERATION CORE PULVERIZER

(71) Applicant: Randy Heying, Alton, IA (US)

(72) Inventor: Randy Heying, Alton, IA (US)

(21) Appl. No.: 13/586,937

(22) Filed: Aug. 16, 2012

Related U.S. Application Data
(60) Provisional application No. 61/525,058, filed on Aug. 18, 2011.

(51) Int. Cl. A01B 45/00; A01B 49/02

(52) U.S. Cl. 172/145

(57) ABSTRACT

An aeration core pulverizer for crushing aeration cores created by turf aeration devices and for dispersing the resulting particulate so as to be reintegrated with the ground, and so that remaining tufts of grass may be easily blown away or removed during mowing. The aeration core pulverizer may include a carriage for mounting a plurality of rows of tines, a brush assembly and a mat, each of which are positioned on the carriage in an arrangement which serves to crush the aeration cores into increasingly smaller pieces. In addition, the rows of tines, the brush assembly and the mat are designed to cooperate together to distribute the particulate across the surface of the ground. The carriage may further include a shaft for mechanically securing the aeration core pulverizer to any suitably designed vehicle, such that it may be pulled across the surface of a turf.

### CROSS-REFERENCE TO RELATED APPLICATION

The present application claims priority to and incorporates herein by reference U.S. Provisional Patent Application Ser. No. 61/525,058 filed on Aug. 18, 2011.

### BACKGROUND OF THE INVENTION

The present invention relates generally to an aeration core pulverizer, more particularly, to a device for attachment to a towing machine, such an existing golf cart or tractor or similar machine and which is designed to break up aeration cores created by turf aeration devices and disperse the resulting components so that they may be reintegrated with or easily removed from the ground.

Turf aeration devices are typically designed to cut and remove a multitude of aeration cores from the turf. This type of turf aeration is beneficial because this process improves turf drainage, reduces turf compaction, allows air and fertilizer to reach the roots of the grass and provides oxygen to worms and other microfauna. Golf courses may also use the holes left after aeration coring to change the composition of sub-surface layers on greens by spreading sand and/or other compositions across greens. Aeration is particularly important for turfs which bear heavy foot and vehicle traffic, such as golf course greens, parks, sports fields and other public spaces. The downside of aeration is that the turf cores removed during the aeration process are typically left scattered across the surface of the turf. In addition to being unsightly, the cores need to be removed or processed where they lay and the remaining holes filled with top dressing. Removal can be expensive, time consuming and require more top dressing be used than is often desirable.

Thus, it would be advantageous to develop an aeration core pulverizer which is designed to crush and separate the aeration cores created by turf aeration into their smaller components, dispersing the particulates so that they are no longer noticeable and making the remaining remnants (of grass roots and tufts) easily removed by mowing or blowing away.

### SUMMARY OF THE INVENTION

The present invention is directed to an aeration core pulverizer which is designed to crush aeration cores created by turf aeration devices and for separating the components of these cores so that particulate may be reintegrated with the ground, and the remaining tufts of grass may be blown away or removed by future mowings. The aeration core pulverizer may also be used to further incorporate additional sand into golf course greens, and to brush the blades of grass before a mowing so that the blades stand up for better manicuring.

The aeration core pulverizer may include a carriage for mounting the component parts of the present invention. The component parts of the aeration core pulverizer include a plurality of rows of tines, a brush assembly and a mat, each of which are positioned on the carriage in an arrangement which serves to crush the aeration cores into increasingly smaller pieces. In addition, the rows of tines, the brush assembly and the mat are designed to cooperate together to distribute the crushed cores across the surface of the ground. The carriage may further include a shaft for mechanically securing the aeration core pulverizer to any suitably designed vehicle, such that it may be pulled across the surface of a turf.

Specifically, each of the rows of tines may be operably secured to the carriage, said rows of tines serving to break up the largest pieces of cores created by the aeration process. The brush assembly may also be secured to the carriage, housed between the rows of tines and the mat. The brush assembly may further include a brush housing having a plurality of bristle channels, each bristle channel designed to hold a plurality of rows of bristles which are specifically designed to aid in pulverizing and distributing the components of the cores created by the turf aeration process. The mat may be secured to the carriage by an attachment mechanism, and the bottom face of the mat may have a plurality of grooves which are designed for engaging directly with the ground.

Specific advantages and features of the present assembly will be apparent from the accompanying drawings and the description of several illustrative embodiments of the present invention.

### DESCRIPTION OF THE DRAWINGS

FIG. 1 illustrates a perspective view of one embodiment of an aeration core pulverizer of the present invention.

FIG. 2 is a perspective view of one embodiment of a carriage of the aeration core pulverizer of the present invention.

FIG. 3A is a side elevation view of a brush assembly of the aeration core pulverizer of the present invention.

FIG. 3B is a perspective view of a plurality of bristles secured within a bristle channel for integration into the brush assembly of FIG. 3A.

FIG. 4A is a side perspective view of a mat of the aeration core pulverizer of the present invention.

FIG. 4B is an exploded view of the mat of FIG. 4A.

It should be understood that the present drawings are not necessarily to scale and that the embodiments disclosed herein are sometimes illustrated by fragmentary views. In certain instances, details which are not necessary for an understanding of the present invention or which render other details difficult to perceive may have been omitted. It should also be understood that the invention is not necessarily limited to the particular embodiments illustrated herein. Like numbers utilized throughout the various figures designate like or similar parts or structure.

### DETAILED DESCRIPTION

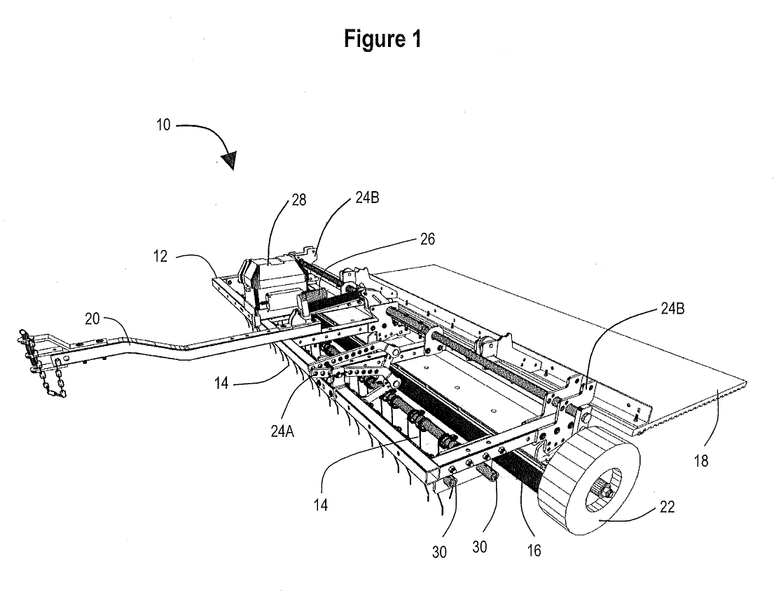

Referring now to the drawings, more particularly by reference numbers, FIG. 1 illustrates one embodiment of the aeration core pulverizer 10 constructed in accordance with the teachings of the present invention. The present aeration core pulverizer 10 is configured for breaking up aeration cores created by turf aeration devices and for dispersing the resulting components, grass and other particulate so that it may be reintegrated with the ground and/or easily mowed or blown off. The aeration core pulverizer 10 may include a carriage 12 to which other components of the present invention are mounted. The aeration core pulverizer 10 may further include at least one row, and preferably at least two rows of tines 14, a brush assembly 16 and a mat 18. Each of the rows of tines 14, the brush assembly 16 and the mat 18 are mounted to the carriage 12, and are positioned thereon in an arrangement which serves to crush the aeration cores into increasingly smaller pieces. In addition, each of the rows of tines 14, the brush assembly 16 and the mat 18 are designed to cooperate together to break up the cores, and to disperse the resulting sand and soil back into the ground, while remaining tufts of grass may be blown away or removed by future mowings. It is further envisioned that the present invention may additionally and/or alternatively be used to incorporate top dressings into greens, and to brush the turf to stand up the grass fibers for better mowing.

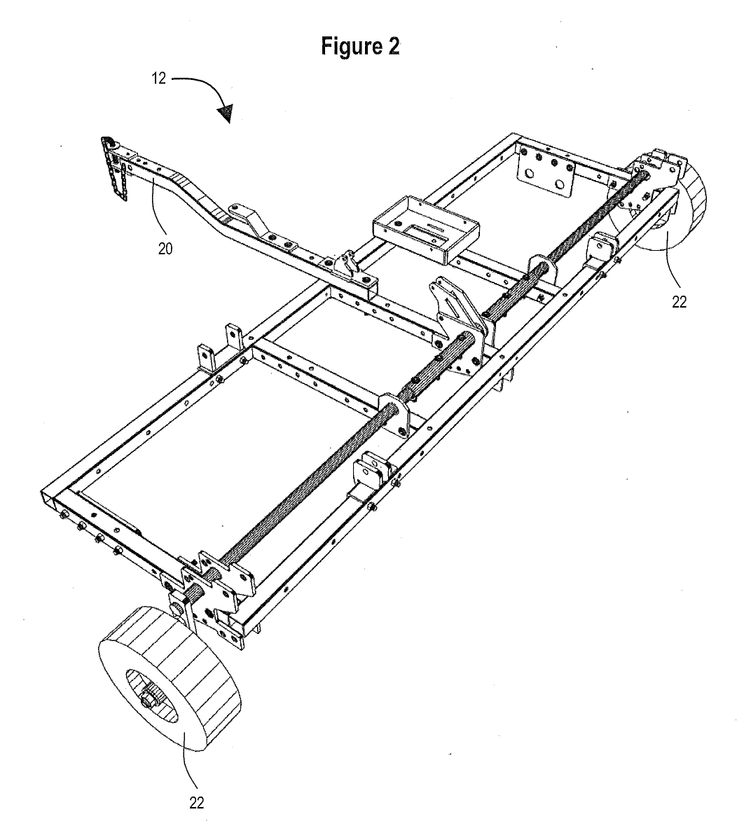

As illustrated in FIGS. 1 and 2, the carriage 12 includes a shaft 20 for mechanically securing the aeration core pulverizer 10 to a towing machine or anything similar, such that it may be pulled across the turf. The carriage 12 may further include a plurality of wheels 22 which cooperate with the machine in order to facilitate movement and to position the present invention for direct engagement with the ground. In one embodiment, the carriage 12 may include a plurality of adjustable brackets 24A, 24B which allow for adjusting the position of each of the rows of tines 14, and the brush assembly 16, respectively, for engagement or disengagement with the turf. In one embodiment, the mat 18 may also be adjustable, or may simply be removed when the mat 18 is not needed. Such adjustable brackets 24A, 24B may allow for the tines 14 and the brush assembly 16 to be, for example, raised out of or lowered into contact with the ground. Alternatively, the adjustable brackets 24A, 24B may allow for angular adjustment of the tines 14 and the brush assembly 16 to be rotated into or out of contact with the ground. Adjustment of the position of the tines 14 and the brush assembly 16 and/or the mat 18 may be controlled mechanically or electronically. Electronic adjustment preferably utilizes a microprocessor 28 in electronic communication with a motor/actuator to effectuate the adjustment of the rows of tines 14 and/or the brush assembly 16, for example via a lever or screw mechanism 26. Mechanical adjustment may be accomplished through a manual lever or screw mechanism 26, as would be understood by one of ordinary skill in the art. However, it will be understood that other means and systems may be used to adjust the position of such components. The carriage 12 thus serves to position the component parts of the present invention in a configuration which facilitates the crushing and dispersion of aeration cores, as will be hereinafter further described.

FIG. 1 further illustrates a plurality of rows of tines 14 operably secured to the carriage 12. The rows of tines 14 may serve to begin breaking up the largest pieces of aeration cores created by the aeration process. In one embodiment, the rows of tines 14 may include a plurality of spring tines which may be individually adjusted and/or replaced as necessary. Furthermore, the rows of tines 14 may be adjustable, such that they may be engaged when their use is desired. In one embodiment, the rows of tines 14 may be positioned on at least one member 30 which is housed within the carriage 12 and which is substantially parallel to the brush assembly 16 and the mat 18. It is envisioned that in alternative embodiments, the carriage 12 may include a plurality of members 30 upon which a plurality of rows of tines 14 may be secured, as desired without departing from the spirit and scope of the invention.

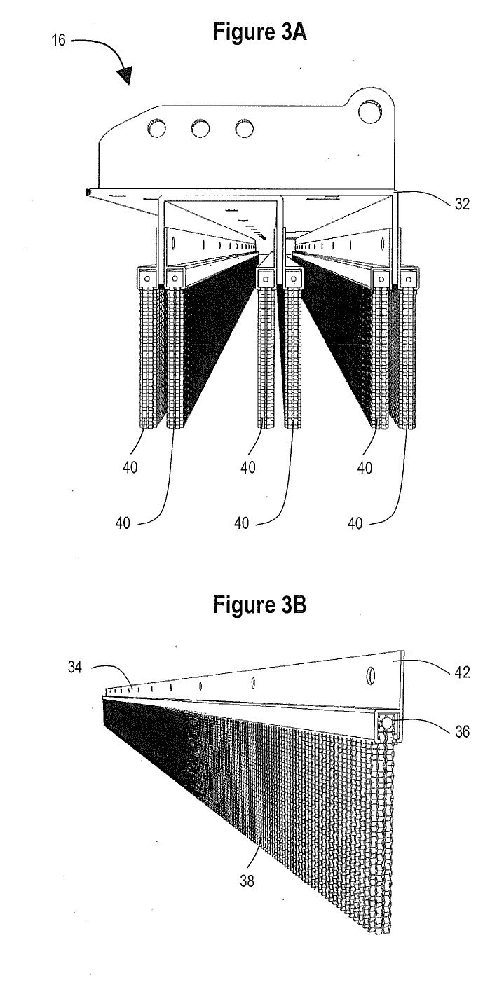

As illustrated in FIGS. 3A and 3B, the brush assembly 16 may be secured to the carriage 12, preferably positioned between the rows of tines 14 and the mat 18. The brush assembly 16 may include a brush frame 32 which further supports a plurality of preferably substantially parallel bristle channels 34. In one embodiment, each of the bristle channels 34 may be organized into pairs operably secured within the brush housing 32. This configuration facilitates the crushing of aeration cores and the distribution of the resulting particulate. In one embodiment, each bristle channel 34 may have a length of about 72 inches, a height of about 1.25 inches and a width of about 0.45 inches. The channel portion 36 of the bristle channel 34 serves to receive and secure the tops of the bristles 38, the wall forming said channel portion 36 preferably having a height of about 0.48 inches and a width of about 0.45 inches, the opening into the channel having a width of about 0.235 inches and the space forming the channel being about 0.346 inches in both height and width. The individual bristles 38 within each row of bristles 40 are thus housed within a bristle channel 34, each of the bristle channels 34 for grouping a plurality of bristles 38 together. Each bristle channel 34 may further include a bracketing member 42 preferably having a height of about 0.77 inches which is secured to the top of the channel portion 36, the bracketing member 42 further including a plurality of circular openings (each having a diameter of about 0.3215 inches) spaced across the face of the bracket for affixing each bristle channel 34 to the brush frame 32 and carriage 12. In one embodiment the bristles 38 may be fashioned from any suitable brush material including, but not limited to, nylon, wire, silicate, polyethylene, styrene, polypropylene, polyurethane and the like. Preferably, a bristle 38 is constructed from polypropylene. Each of the individual bristles 38 may be substantially crimped and preferably have a length of about 3.875 inches, a width of about 0.056 inches and a thickness of about 0.040 inches. Furthermore, about the top 0.375 inches of each bristle 38 may be secured within each, bristle channel 34 in a manner which causes the remaining length of each bristle 38 (about 3.50 inches) to flare out.

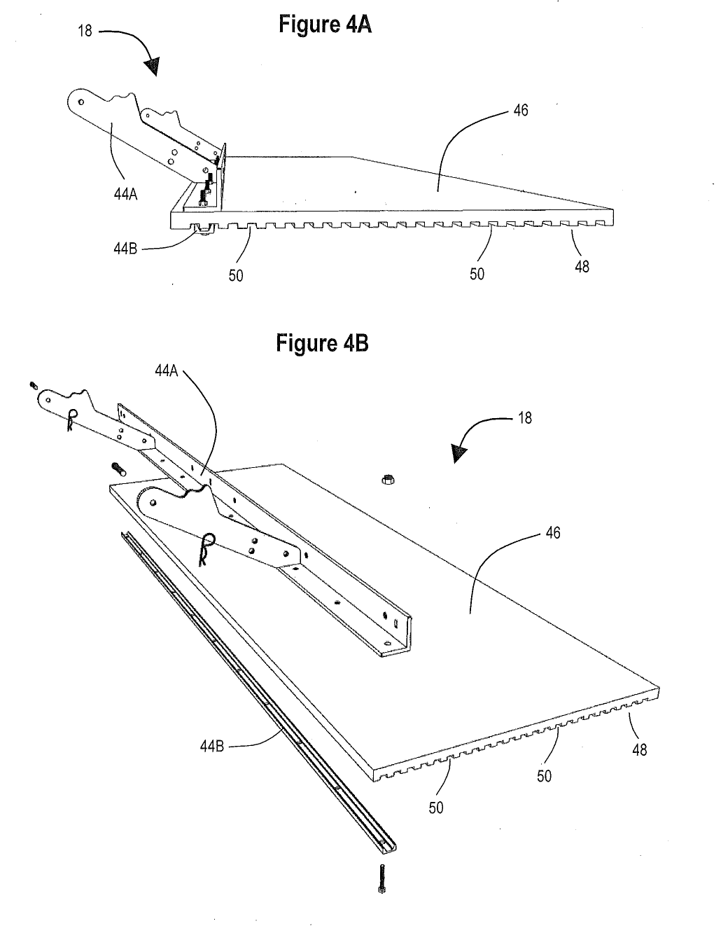

As illustrated in FIGS. 4A and 4B, the mat 18 may be secured to the carriage 12 by an attachment mechanism. Specifically, the attachment mechanism upper portion 44A may be attached to the top face 46 of the mat 18, while a attachment mechanism U-channel 44B may be attached to the bottom face 48 of the mat 18, engaging with the upper portion 44A to sandwich the mat 18 therebetween. The bottom face 48 of mat 18 preferably engages directly with the ground. In one embodiment, the attachment mechanism 44A/44B may be adjustable, such that the mat 18 may be engaged when its use is desired and disengaged so that it may be stored on the carriage 12 and does not engage with the grass. In another embodiment, the mat 18 may be removable from the carriage 12 when its use is not needed. The bottom face 48 preferably includes a plurality of laterally extending grooves 50 which cooperate with the rows of tines 14 and the brush assembly 16 by further breaking up the aeration cores created by the aeration process and distribute the resulting sand and soil particulate for reintegration with the ground.

Thus, there has been shown and described an embodiment of a novel aeration core pulverizer. As is evident from the foregoing description, certain aspects of the present invention are not limited by the particular details of the examples illustrated herein, and it is therefore contemplated that other modifications and applications, or equivalents thereof, will occur, to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An aeration core pulverizer comprising:
A carriage;
a least one row of tines connected to the carriage;
a brush assembly connected to the carriage, the brush assembly including at least one row of bristles; and
a mat connected to the carriage.

2. An aeration core pulverizer of claim 1 wherein each, of the rows of tines are adjustable.

3. An aeration core pulverizer of claim 1 wherein each of the rows of tines further includes a plurality of spring tines.

4. An aeration core pulverizer of claim 1 wherein the brush assembly is adjustable.

5. An aeration core pulverizer of claim 1 wherein the brush assembly further includes a brush frame.

6. An aeration core pulverizer of claim 5 wherein the brush frame further includes a plurality of bristle channels, each bristle channel designed to support a row of bristles.

7. An aeration core pulverizer of claim 6 wherein each of the bristles is crimped.

8. An aeration core pulverizer of claim 6 wherein each of the bristles is made of polypropylene.

9. An aeration core pulverizer of claim 1 wherein the mat is removable.

10. An aeration core pulverizer of claim 1 wherein the mat further includes a plurality of grooves extending across the bottom face of the mat.

11. An aeration core pulverizer of claim 1 wherein the carriage further includes a shaft for securing said aeration core pulverizer to a machine.

12. An aeration core pulverizer of claim 1 wherein the carriage further includes a plurality of wheels.

13. An aeration core pulverizer of claim 1 wherein the aeration core pulverizer further includes a microprocessor and actuator.

14. An aeration core pulverizer of claim 13 wherein the microprocessor is electrically connected to an adjustment mechanism for adjusting the position of at least one of a row of tines, the brush assembly and the mat.
